(19) United States
(12) Patent Application Publication
(10) Pub. No.: US 2025/0390743 A1
(43) Pub. Date: Dec. 25, 2025

(54) SYSTEM, METHOD, AND COMPUTER ACCESSIBLE MEDIUM FOR REINFORCEMENT LEARNING FROM OMICS FEEDBACK

(71) Applicant: NEW YORK UNIVERSITY, New York, NY (US)

(72) Inventor: Eric Karl OERMANN, Chapel Hill, NC (US)

(73) Assignee: NEW YORK UNIVERSITY, New York, NY (US)

(21) Appl. No.: 19/246,555

(22) Filed: Jun. 23, 2025

Related U.S. Application Data
(60) Provisional application No. 63/662,815, filed on Jun. 21, 2024.

(51) Int. Cl. G06N 3/08

(52) U.S. Cl. CPC G06N 3/08

(57) ABSTRACT

Method, system and computer-accessible medium can be provided for generating one or more drug conjugates of one or more small molecules. For example, with such exemplary method, system and computer-accessible medium, a multimodal discriminative model can be trained to predict at least one peptide-ligand binding for one or more DNA ligands, a generative nucleotide model can be trained to generate a plurality of compounds. Further, a feedback can be provided from the multimodal discriminative model to fine-tune the generative nucleotide model so as to facilitate the generation of the drug conjugate(s).

### CROSS-REFERENCE TO RELATED APPLICATION(S)

This application relates to and claims priority from U.S. Patent Application No. 63/662,815, filed on Jun. 21, 2024, the entire disclosure of which is incorporated herein by reference.

### FIELD OF THE DISCLOSURE

The present disclosure relates generally to systems, methods and computer-accessible medium for creating and employing discriminative and generative language models to predict an underlying biological phenomenon and to optimize compounds designed to achieve it.

### BACKGROUND INFORMATION

Language models have impressive capabilities, and generative language model are increasingly being deployed in the context of genomics. However, what makes a “good” generated sequence can be difficult to define beyond simple fidelity to the underlying biology in the context of predicting the next nucleotide or peptide. However, it is a question as to whether generative models can be used to generate novel peptides or novel nucleotides. Reinforcement Learning from Human Feedback (RLHF) uses reinforcement learning to directly optimize a language model with human feedback. RLHF has enabled language models to begin to align a model trained on a general corpus of text data to that of complex human values. RLHF's most recent success was its use in ChatGPT. However, in the biomedical domain RLHF has the notable shortcoming of not having a strong human preference signal.

Thus, it can be beneficial to provide an alternative to RLHF by using feedback from another AI model that has been optimized to predict a given biophysical or biochemical parameter. A recently developed multimodal model, OmniBioTA, can provide state-of-the-art predictions of binding energy between peptides and nucleotides. Using OmniBioTA as a way to provide Reinforcement Learning from Omics Feedback (RLOF), a generative nucleotide model can be fine-tuned to synthesize small nucleotide sequences that will optimally bind a given peptide. This process can also be combined with other, non-AI models for feedback such as existing simulations of molecular dynamics or other existing predictive models. The key insight is a system that combines a multimodal Large Language Model (LLM) trained on genomics+proteomics data to fine tune a generative nucleotide model. This feedback signal can be further augmented by other molecular dynamics simulations, quantum simulations, or other forms of feedback.

### SUMMARY OF EXEMPLARY EMBODIMENTS

The following is intended to be a brief summary of the exemplary embodiments of the present disclosure, and is not intended to limit the scope of the exemplary embodiments.

In some exemplary embodiments of the present disclosure, the exemplary systems, methods, and computer accessible medium can be provided for generating one or more drug conjugates of one or more small molecules. The exemplary systems, methods, and computer accessible medium can, e.g., train a multimodal discriminative model to predict at least one peptide-ligand binding for one or more DNA ligands, train a generative nucleotide model to generate a plurality of compounds, and provide a feedback from the multimodal discriminative model to fine-tune the generative nucleotide model so as to facilitate the generation of the one or more drug conjugates. The at least one molecule of the one or more small molecule drug conjugates can be an aptamer. The generation of the one or more drug conjugates can also be based on at least one input conditioning vector comprising a primary or tertiary structure embedding of an intended protein target, a chemical descriptor of the payload, or a desired pharmacokinetic anchor. In some embodiments, a plurality of candidate drug conjugates can be generated and scored. The candidate drug conjugates can be scored by one or more of a target binding classifier, a serum stability predictor, and a off-target liability assessor. Also, a molecular simulation can be conducted on a subset of the scored plurality of candidate drug conjugates to validate and refine at least one property of each of the subset of scored candidate drug conjugates

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary illustration of a method for using quantum computing to generate and/or rank aptamer candidates according to an exemplary embodiment of the present disclosure;

FIG. 2 is an exemplary illustration for training and using an AI model for generating and/or ranking aptamer candidates according to an exemplary embodiment of the present disclosure;

FIG. 3 is an exemplary illustration of using an AI model for generating and/or ranking aptamer candidates according to an exemplary embodiment of the present disclosure;

FIG. 4 is a set of exemplary graphs showing scaling figures for protein and DNA according to an exemplary embodiment of the present disclosure;

FIG. 5 is a set of exemplary graphs showing scaling figures for protein and DNA according to an exemplary embodiment of the present disclosure;

FIG. 6 (a) is a set of exemplary graphs showing exemplary nucleotide-peptide binding results, namely binding affinity between nucleotide and peptide sequence according to an exemplary embodiment of the present disclosure;

FIG. 6 (b) is an exemplary graph showing exemplary nucleotide-peptide binding results, namely, given a single nucleotide mutation, the effect of mutation on binding affinity according to an exemplary embodiment of the present disclosure;

FIG. 7 is a set of exemplary illustrations providing an indication whether binding sites or learning nucleotide/protein relationships (codons) can be identified, according to an exemplary embodiment of the present disclosure; and

FIG. 8 is an illustration of an exemplary block diagram of an exemplary system in accordance with certain exemplary embodiments of the present disclosure.

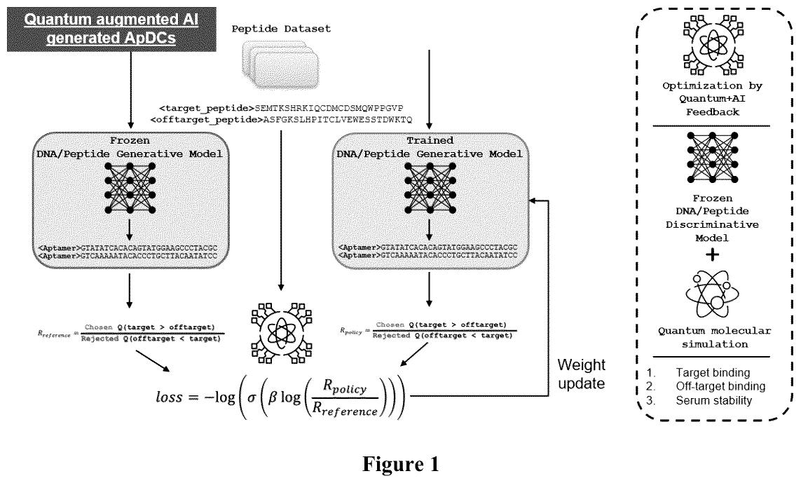

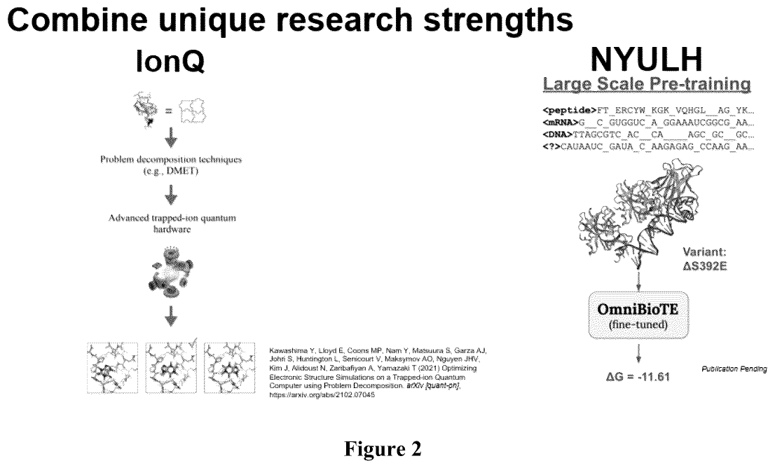

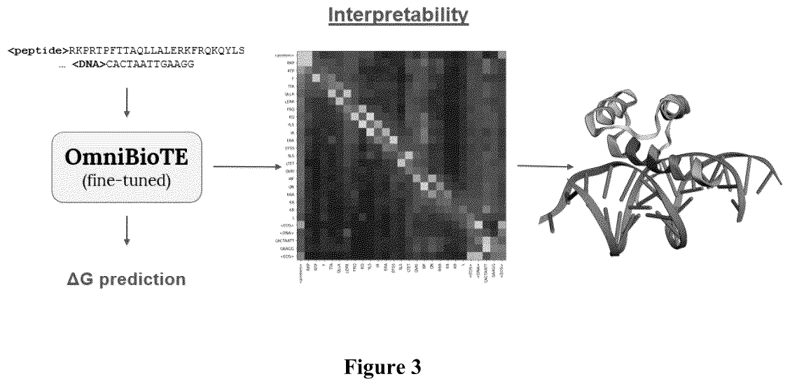

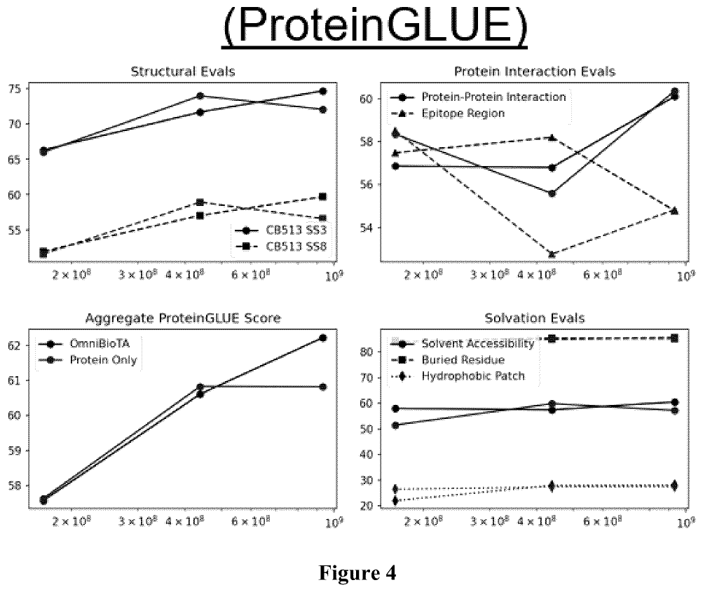

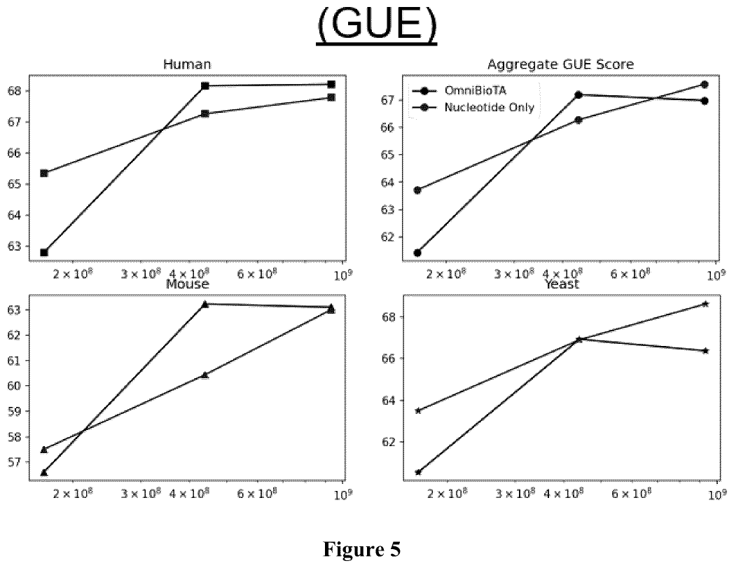

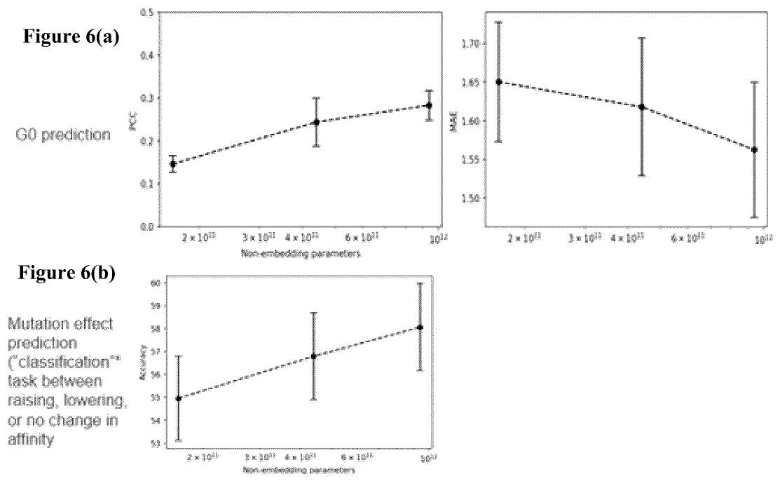

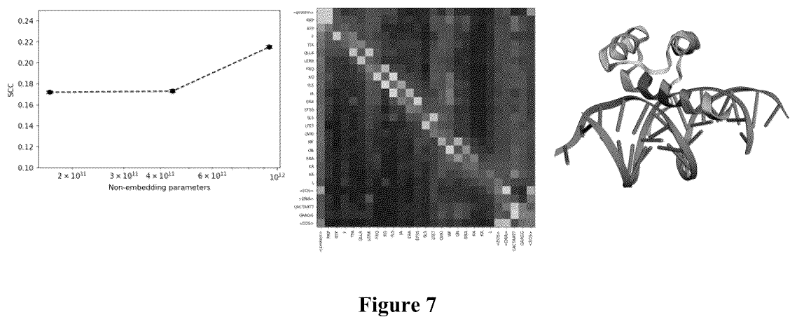

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The following description of exemplary embodiments provides non-limiting representative examples referencing numerals to particularly describe features and teachings of different exemplary aspects and exemplary embodiments of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the exemplary embodiments of the present disclosure to such an extent that other implementations, not specifically covered but within the knowledge of a person of skill in the art having read the description of embodiments, would be understood to be consistent with an application of the exemplary embodiments of the present disclosure.

### Exemplary Problem

In early-stage clinical trials, approximately 80-90 percent of small-molecule and biologic drug candidates fail prior to or during Phase I/II, contributing to an average R&D expenditure of $1.5-3 billion per approved therapy. Major causes of attrition include poor pharmacokinetics (e.g., rapid clearance, suboptimal bioavailability), unforeseen immunogenicity leading to adverse immune responses, and insufficient on-target engagement despite promising in vitro activity.

Current protein structural prediction platforms (e.g., AlphaFold2, RosettaFold) excel at generating high-accuracy static models of individual proteins, yet they do not inherently address dynamic ligand-protein interactions or off-target binding across the full proteome. Such tools yield a single “snapshot” conformation and fail to capture ensemble behaviors induced by post-translational modifications, allosteric transitions, or protein-protein interactions. Consequently, virtual screening efforts based solely on static pockets often produce high false positive rates; small molecules predicted to dock favorably may never reach or stably bind the intended site in a cellular context. Off-target liabilities-such as unintended inhibition of hERG channels or cytochrome P450 isoforms-remain difficult to predict without integrating large-scale sequence and functional datasets.

### Exemplary Aptamers As A New Drug Modality

Aptamer drug conjugates (ApDCs) can combine the programmability of nucleic acids with the potency of therapeutic payloads (e.g., cytotoxins, radionuclides), but conventional ApDCs suffer from limited in vivo stability, low specificity, and rapid renal clearance. Unmodified DNA or RNA aptamers are prone to nuclease degradation, with serum half-lives often under two hours, requiring extensive 2′-modifications (e.g., 2′-fluoro, 2′-O-methyl) that can diminish binding affinity. Early ApDC prototypes targeting nucleolin (e.g., AS1411-based conjugates) achieved reasonable tumor localization yet exhibited off-target accumulation in liver and kidney, leading to narrow therapeutic windows and complex dosing regimens. Furthermore, heterogeneous folding can create subpopulations of non-binding conformers, undermining overall specificity.

Exemplary Design: Aptamers are short, single-stranded oligonucleotides (˜20-60 nt, 5-15 kDa) that can be precisely encoded and chemically synthesized, in contrast to ˜150 kDa monoclonal antibodies. The exemplary systems, methods, and computer accessible medium according to the exemplary embodiments of the present disclosure provide a reinforcement learning (RL) fine-tuned genomics-proteomics LLM to propose aptamer sequences optimized both for high-affinity binding and nuclease resistance. The RL reward function can assign positive scores for predicted improvements in binding free energy-which can be estimated via integrated docking and molecular-dynamics surrogate models-and negative scores for sequence motifs known to be susceptible to exonuclease activity. Through iterative RL-guided sequence refinement, the LLM of the exemplary systems, methods, and computer accessible medium according to the exemplary embodiments of the present disclosure can converge on aptamers incorporating strategic 2′-O-methyl and 2′-fluoro modifications in loop regions, achieving sub-nanomolar K_d predictions alongside projected serum half-lives exceeding 24 hours.

Exemplary Mechanism: The exemplary systems, methods, and computer accessible medium according to the exemplary embodiments of the present disclosure provide RL-fine-tuned LLMs that can enable precision tuning of aptamer specificity by incorporating negative sampling against panels of homologous or off-target proteins during training. In one exemplary embodiment, the reward function can include penalties for predicted binding to PD-L2 and other B7 family members, while rewarding high-confidence interactions with PD-L1. The resulting aptamer can selectively block the PD-1/PD-L1 immune-checkpoint axis without cross-reactivity to PD-L2, leading to potent T-cell activation in vitro and in vivo with reduced cytokine-release syndrome compared to reference monoclonal antibodies. The flexibility in sequence design and target discrimination of the exemplary systems, methods, and computer accessible medium according to the exemplary embodiments of the present disclosure exceeds the capabilities of small molecules, antibodies, or antibody-drug conjugates, offering a versatile platform for therapeutic and diagnostic applications.

Exemplary CMC: The exemplary systems, methods, and computer accessible medium according to the exemplary embodiments of the present disclosure can produce results that are more chemically stable than mAb, with readily scalable manufacture.

ADCs can be used, e.g., as an established mode for attaching protein targeter to effect warhead. Aptamers used by Somalogic etc, as probes of specific proteins ApDCs show considerable promise (He et al 2024, ncbi/pmc/articles/PMC10150127).

### Exemplary Solution

The exemplary systems, methods, and computer accessible medium according to the exemplary embodiments of the present disclosure can generate a plurality of candidate ApDCs (aptamer-drug conjugates) and then apply a multi-stage optimization pipeline to select those constructs predicted to exhibit high target affinity, enhanced serum half-life, and minimal off-target interactions. This pipeline comprises three principal stages:
Aptamer-drug conjugate generation
   A transformer-based or diffusion-based generative model of the exemplary systems, methods, and computer accessible medium according to the exemplary embodiments of the present disclosure can be fine-tuned on a corpus of known aptamer sequences, drug cargo linkers, and conjugation chemistries. Input conditioning vectors can include: (i) the primary or tertiary structure embedding of the intended protein target; (ii) chemical descriptors of the payload (e.g., small molecule cytotoxin, radionuclide chelator, siRNA); and (iii) desired pharmacokinetic “anchors” (such as motifs known to evade nuclease cleavage). The generative AI model of the exemplary systems, methods, and computer accessible medium according to the exemplary embodiments of the present disclosure can then propose novel sequence-linker-payload assemblies by sampling from its learned latent space, yielding a library of N candidate ApDC constructs.
Optimize generated compounds:
   The exemplary systems, methods, and computer accessible medium according to the exemplary embodiments of the present disclosure can then score all N generated candidates with a suite of discriminative neural networks, each trained to predict a specific property:
      Target Binding Classifier: trained on experimental K_d/K_i datasets and can output an affinity score (e.g., log-transformed).
      Serum Stability Predictor: a recurrent-neural-network model according to the exemplary systems, methods, and computer accessible medium according to the exemplary embodiments of the present disclosure that can estimate half-life in human serum based on sequence motifs and predicted secondary structure.
      Off-Target Liability Assessor: a multi-task classifier of the exemplary systems, methods, and computer accessible medium according to the exemplary embodiments of the present disclosure that can flag predicted binding to a panel of known off-targets (e.g., hERG, cytochrome P450 isozymes, common nuclease/exonuclease motifs).
      The exemplary systems, methods, and computer accessible medium according to the exemplary embodiments of the present disclosure can assign a “fitness” vector to each candidate which can then be ranked. A Pareto front of top-scoring constructs (e.g., top 5-10%) can be selected by the exemplary systems, methods, and computer accessible medium according to the exemplary embodiments of the present disclosure for further quantum mechanical evaluation.
Molecular simulation
   The exemplary systems, methods, and computer accessible medium according to the exemplary embodiments of the present disclosure can direct in silico quantum and molecular dynamics (MD) simulations of the Pareto-optimal subset to validate and refine predicted properties such as minimizing toxicity or maximizing binding.

### Exemplary Reducing Off-Target Effects And Stabilizing In Serum

Serum stability optimization can be further augmented through in vitro screening stage. The exemplary systems, methods, and computer accessible medium according to the exemplary embodiments of the present disclosure can screen aptamer and ApDC compounds in serum in a massively multiplexed fashion. The following can be performed by synthesizing to minimize off-target binding against proteome minimize off-target effects, and/or minimizing (or reducing) off-target enzymatic binding naturally can enhance serum stability.

The exemplary systems, methods, and computer accessible medium according to the exemplary embodiments of the present disclosure can provide benefits from aptamer's general fast penetration, low immunogenicity. The exemplary systems, methods, and computer accessible medium according to the exemplary embodiments of the present disclosure can deliver greater serum stability of the Aptamers using the Aptamers and possible Methylation/Acetylation. Exemplary models of the exemplary systems, methods, and computer accessible medium according to the exemplary embodiments of the present disclosure can be trained with feedback from dropping aptamers into serum to see how stable they are after K-hours. This can be excluded if AptDC because just need to target the drug conjugates, or can be purchased. Further, the exemplary systems, methods, and computer accessible medium according to the exemplary embodiments of the present disclosure can natively stabilize in serum by predicting the enzymes that might chew up the aptamers.

Exemplary systems, methods and computer-accessible medium according to exemplary embodiments of the present disclosure can address and/or solve the problem of discriminative and generative language models outputting results that are not consistent with human preferences regarding their biological properties. By providing an exemplary system of predictive models, it is possible to predict the underlying biological phenomenon and the other to optimize compounds designed to achieve it we can better generate novel nucleotide and peptide sequences for subsequent drug discovery efforts.

An exemplary application of exemplary systems, methods and computer-accessible medium according to exemplary embodiments of the present disclosure is to encourage LLMs to perform the intended actions by physicians (physician-AI alignment). Exemplary systems, methods and computer-accessible medium according to exemplary embodiments of the present disclosure can be used to utilize these techniques to further improve LLMs.

### Exemplary Embodiments of the Present Disclosure

An exemplary multimodal discriminative model for predicting peptide-ligand binding for DNA ligands according to the exemplary embodiments of the present disclosure can be provided. For example, a generative nucleotide model for generating compounds (e.g., including another generative model such as for small molecules) can be provided.

According to another exemplary embodiment of the present disclosure, a system for providing feedback of a multimodal discriminative model can be provided for predicting peptide-ligand binding for DNA ligands to fine tune a generative nucleotide model for generating compounds.

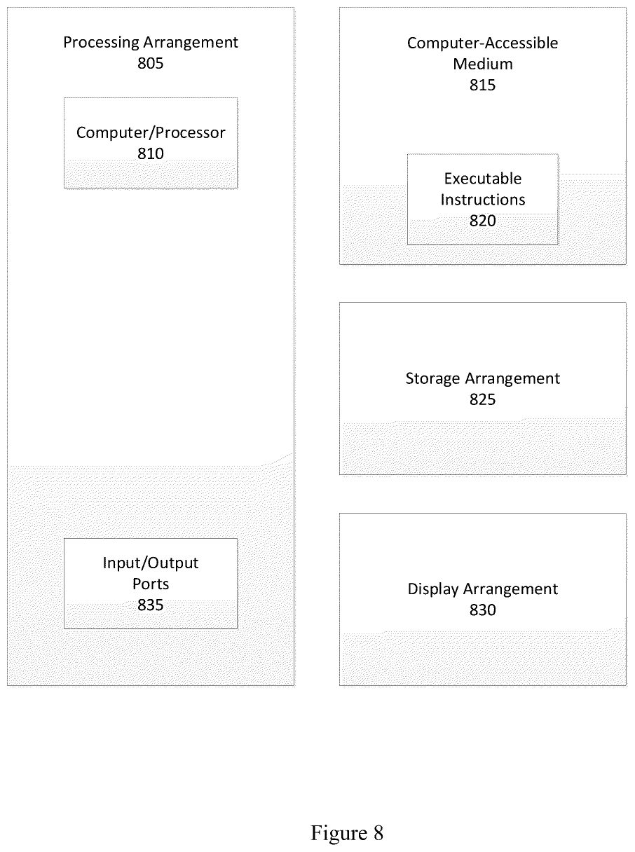

FIG. 8 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 805. Such processing/computing arrangement 805 can be, for example entirely or a part of, or include, but not limited to, a computer/processor 810 that can include, for example one or more microprocessors, and use instructions stored on a computer-accessible medium (e.g., RAM, ROM, hard drive, or other storage device).

As shown in FIG. 8, for example a computer-accessible medium 815 (e.g., as described herein above, a storage device such as a hard disk, floppy disk, memory stick, CD-ROM, RAM, ROM, etc., or a collection thereof) can be provided (e.g., in communication with the processing arrangement 805). The computer-accessible medium 815 can contain executable instructions 820 thereon. In addition or alternatively, a storage arrangement 825 can be provided separately from the computer-accessible medium 815, which can provide the instructions to the processing arrangement 805 so as to configure the processing arrangement to execute certain exemplary procedures, processes, and methods, as described herein above, for example. Further, the exemplary processing arrangement 805 can be provided with or include an input/output ports 835, which can include, for example a wired network, a wireless network, the internet, an intranet, a data collection probe, a sensor, etc. As shown in FIG. 8, the exemplary processing arrangement 805 can be in communication with an exemplary display arrangement 830, which, according to certain exemplary embodiments of the present disclosure, can be a touch-screen configured for inputting information to the processing arrangement in addition to outputting information from the processing arrangement, for example. Further, the exemplary display arrangement 830 and/or a storage arrangement 825 can be used to display and/or store data in a user-accessible format and/or user-readable format.

According to yet another exemplary embodiments of the present disclosure, various specific details can be provided. For example, the various exemplary implementations of the exemplary embodiments of the present disclosure can be provided and/or practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one exemplary embodiment,” or “in one implementation” does not necessarily refer to the same example, exemplary embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

The foregoing merely illustrates the principles of the disclosure. Various modifications and alterations to the described embodiments can be apparent to those skilled in the art in view of the teachings herein. It can thus be appreciated that those skilled in the art can be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

This written description uses examples to disclose certain implementations of the disclosed technology, including the best mode, and also to enable any person skilled in the art to practice certain implementations of the disclosed technology, including making and using any devices or systems and performing any incorporated methods.

### EXEMPLARY REFERENCES

The following references are hereby incorporated by reference, in their entireties:
1. Chabner, B. A. & Roberts, T. G., Jr. Timeline: Chemotherapy and the war on cancer. Nat. Rev. Cancer 5, 65-72 (2005).
2. Komorowski, M., Celi, L. A., Badawi, O., Gordon, A. C. & Faisal, A. A. The Artificial Intelligence Clinician learns optimal treatment strategies for sepsis in intensive care. Nat. Med. (2018) doi: 10.1038/s41591-018-0213-5.
3. Jeter, R., Josef, C., Shashikumar, S. & Nemati, S. Does the “Artificial Intelligence Clinician” learn optimal treatment strategies for sepsis in intensive care? arXiv [cs.AI] (2019).
4. Joranger, P. et al. Modeling and validating the cost and clinical pathway of colorectal cancer. Med. Decis. Making 35, 255-265 (2015).
5. Karnon, J. & Brown, J. Selecting a decision model for economic evaluation: a case study and review. Health Care Manag. Sci. 1, 133-140 (1998).
6. Lee, J. H., Glick, H. A., Hayman, J. A. & Solin, L. J. Decision-analytic model and cost-effectiveness evaluation of postmastectomy radiation therapy in high-risk premenopausal breast cancer patients. J. Clin. Oncol. 20, 2713-2725 (2002).
7. Minion, L. E. et al. A Markov model to evaluate cost-effectiveness of antiangiogenesis therapy using bevacizumab in advanced cervical cancer. Gynecol. Oncol. 137, 490-496 (2015).
8. Silva-Illanes, N. & Espinoza, M. Critical analysis of Markov models used for the economic evaluation of colorectal cancer screening: A systematic review. Value Health 21, 858-873 (2018).
9. Akhavan-Tabatabaei, R., Sánchez, D. M. & Yeung, T. G. A Markov decision process model for cervical cancer screening policies in Colombia. Med. Decis. Making 37, 196-211 (2017).
10. Benson, N., Whipple, M. & Kalet, I. J. A Markov model approach to predicting regional tumor spread in the lymphatic system of the head and neck. AMIA Annu. Symp. Proc. 31-35 (2006).
11. de Geus, S. W. L. et al. Neoadjuvant therapy versus upfront surgical strategies in resectable pancreatic cancer: A Markov decision analysis. Eur. J. Surg. Oncol. 42, 1552-1560 (2016).
12. Fujii, T. et al. Prediction of bone metastasis in inflammatory breast cancer using a Markov chain model. Oncologist 24, 1322-1330 (2019).
13. Imani, F., Qiu, Z. & Yang, H. Markov decision process modeling for multi-stage optimization of intervention and treatment strategies in breast cancer. Annu Int Conf IEEE Eng Med Biol Soc 2020, 5394-5397 (2020).
14. Maass, K. & Kim, M. A Markov decision process approach to optimizing cancer therapy using multiple modalities. Math. Med. Biol. 37, 22-39 (2020).
15. Newton, P. K. et al. A stochastic Markov chain model to describe lung cancer growth and metastasis. PLOS One 7, e34637 (2012).
16. Petousis, P. et al. Using sequential decision making to improve lung cancer screening performance. IEEE Access 7, 119403-119419 (2019).
17. Sanyal, C., Aprikian, A., Cury, F., Chevalier, S. & Dragomir, A. Clinical management and burden of prostate cancer: a Markov Monte Carlo model. PLOS One 9, e113432 (2014).
18. Shen, C. et al. Operating a treatment planning system using a deep-reinforcement learning-based virtual treatment planner for prostate cancer intensity-modulated radiation therapy treatment planning. Med. Phys. 47, 2329-2336 (2020).
19. Yazdjerdi, P., Meskin, N., Al-Naemi, M., Al Moustafa, A.-E. & Kovács, L. Reinforcement learning-based control of tumor growth under anti-angiogenic therapy. Comput. Methods Programs Biomed. 173, 15-26 (2019).
20. Tseng, H.-H. et al. Deep reinforcement learning for automated radiation adaptation in lung cancer. Med. Phys. 44, 6690-6705 (2017).
21. Abdollahian, M. & Das, T. K. A MDP model for breast and ovarian cancer intervention strategies for BRCA1/2 mutation carriers. IEEE J. Biomed. Health Inform. 19, 720-727 (2015).

What is claimed is:

1. A method for generating one or more drug conjugates of one or more small molecules, comprising:
training a multimodal discriminative model to predict at least one peptide-ligand binding for one or more DNA ligands;
training a generative nucleotide model to generate a plurality of compounds; and
providing a feedback from the multimodal discriminative model to fine-tune the generative nucleotide model so as to facilitate the generation of the one or more drug conjugates.

2. The method of claim 1, wherein at least one molecule of the one or more small molecule drug conjugates is an aptamer.

3. The method of claim 1, wherein the generation of the one or more drug conjugates is further based on at least one input conditioning vector.

4. The method of claim 3, wherein the at least one input conditioning vector comprises a primary or tertiary structure embedding of an intended protein target, a chemical descriptor of the payload, or a desired pharmacokinetic anchor.

5. The method of claim 1, wherein a plurality of candidate drug conjugates is generated and scored.

6. The method of claim 5, wherein each of the plurality of candidate drug conjugates is scored by one or more of a target binding classifier, a serum stability predictor, and a off-target liability assessor.

7. The method of claim 1, wherein molecular simulation is conducted on a subset of scored plurality of candidate drug conjugates to validate and refine at least one property of each of the subset of scored candidate drug conjugates.

8. A system for generating one or more drug conjugates of one or more small molecules, comprising:
at least one processor configured to:
train a multimodal discriminative model to predict at least one peptide-ligand binding for one or more DNA ligands;
train a generative nucleotide model to generate a plurality of compounds; and
provide a feedback from the multimodal discriminative model to fine-tune the generative nucleotide model to facilitate the generation of the one or more drug conjugates.

9. The system of claim 8, wherein at least one molecule of the one or more small molecule drug conjugates is an aptamer.

10. The system of claim 8, wherein the generation of the one or more drug conjugates is further based on at least one input conditioning vector.

11. The system of claim 10, wherein the at least one input conditioning vector comprises a primary or tertiary structure embedding of an intended protein target, a chemical descriptor of the payload, or a desired pharmacokinetic anchor.

12. The system of claim 8, wherein a plurality of candidate drug conjugates is generated and scored.

13. The system of claim 12, wherein each of the plurality of candidate drug conjugates is scored by one or more of a target binding classifier, a serum stability predictor, and a off-target liability assessor.

14. The system of claim 8, wherein molecular simulation is conducted on a subset of scored plurality of candidate drug conjugates to validate and refine at least one property of each of the subset of scored candidate drug conjugates.

15. A non-transitory computer accessible medium which includes software thereon for generating one or more drug conjugates of one or more small molecules, wherein, when at least one computer processor executes the software, the computer processor is configured to perform the procedures, comprising:
training a multimodal discriminative model to predict at least one peptide-ligand binding for one or more DNA ligands;
training a generative nucleotide model to generate a plurality of compounds; and
providing a feedback from the multimodal discriminative model to fine-tune the generative nucleotide model to facilitate the generation of the one or more drug conjugates.

16. The non-transitory computer accessible medium of claim 15, wherein at least one molecule of the one or more small molecule drug conjugates is an aptamer.

17. The non-transitory computer accessible medium of claim 15, wherein the generation of the one or more drug conjugates is further based on at least one input conditioning vector.

18. The non-transitory computer accessible medium of claim 17, wherein the at least one input conditioning vector comprises a primary or tertiary structure embedding of an intended protein target, a chemical descriptor of the payload, or a desired pharmacokinetic anchor.

19. The non-transitory computer accessible medium of claim 15, wherein a plurality of candidate drug conjugates is generated and scored.

20. The non-transitory computer accessible medium of claim 19, wherein each of the plurality of candidate drug conjugates is scored by one or more of a target binding classifier, a serum stability predictor, and a off-target liability assessor.

21. The non-transitory computer accessible medium of claim 15, wherein molecular simulation is conducted on a subset of scored plurality of candidate drug conjugates to validate and refine at least one property of each of the subset of scored candidate drug conjugates.
